(19) United States
(12) Patent Application Publication
(10) Pub. No.: US 2010/0031511 A1
(43) Pub. Date: Feb. 11, 2010

(54) Pipe Cutter

(76) Inventors: Roderic Henry Vince, Queensland (AU); Heather Fairbairn, Queensland (AU)

Correspondence Address: Roderic Henry Vince;Heather Fairbairn Vince, 3 Sandpiper Cl, Buderim, 4556, omitted

(21) Appl. No.: 12/089,041

(22) PCT Filed: Oct. 6, 2006
(86) PCT No.: PCT/AU2006/001454

§ 371 Date: Sep. 10, 2008

(30) Foreign Application Priority Data
Oct. 6, 2005 (AU) 2005905609

(51) Int. Cl. B23D 21/14; B26D 1/143

(52) U.S. Cl. 30/103; 83/54

(57) ABSTRACT

A mechanical pipe cutting device comprising of a shaft body with a tapered spring loaded internal drive shaft, with interchangeable heads of varying sizes. The sole purpose of the tool is to cut pipes of different sizes from within. Each head has multiple spring loaded blades that are forced outwards by downward pressure. The shaft body has an adjustable depth guide so that the downward pressure of the operator forces the spring loaded tapered drive shaft against the pistons holding the spring loaded cutters. This is all driven by some form of rotational motive power. As downward pressure is applied the cutters are forced into the surrounding pipe. On cutting through the downward pressure is released, the blades retract. The tool is ready to be extracted from the inside of the pipe

This invention relates to cutting all types of pipe, and in particular to cutting these pipes in restricted areas.

There are occasions when a pipe needs to be cut when it is either closely adjacent a surface through which it passes or even below the surface at which it is located and it has been conventionally effectively impossible to do this or, at least to do it neatly and without likely damage to the surface or surround and then incurs reparation works.

An object of the invention is provide a means whereby a pipe can be can from the interior thereof so that the actual location of the pipe is not of relevance as far as being able to cut the pipe.

The invention, in its broad sense, includes a tool for cutting a pipe from the inside which include an elongate body to which there is fitted a cutter heads having a number of cutters which are moveable radially and means whereby the cutters can be forced to move radially outwardly on being contacted by a drive rod.

In a preferred form of invention the drive rod is connected to a source of rotating power and is in itself driveably connected to the tubular body so that on rotation of the power source the body and the cutting head are caused to rotate, the arrangement being such that during such rotation an inward force on the rod causes the outward movement of the cutters.

It is preferred that there is an adjustment plate moveable along the body and retainable in required positions therealong which can act against an outer surface of the pipe being cut which provides an accurate spacing of the cut from the external surface of the pipe and a restraining means against the inward source can act.

In order that the invention can be more readily understood I shall describe one particular embodiment of the pipe cutter.

The cutter has a body which could be 35 mm tube which may be 300 mm long but these dimensions are not critical to the invention. It is necessary that the diameter of each bead be less than the internal diameter of the smallest pipe with which it is to be used.

Passing through the tube and located, preferably, at least adjacent each end thereof there can be a drive shaft which drive shaft extends outwardly from one end of the tube and is to be connected to a power source, such as a power drill.

This drive shaft may be square or otherwise shaped in cross section and have a tapered free end, as will be described later. It has a fixed washer spaced from its lower end which washer is adapted to act as a stop for a helical spring which the other end of which can react against one of the location members or a further apertured member which is connected to the main drive tube so that the shaft, in its rest position, is directed outwardly relative to the tube but can be moved axially within the limits of movements provided by the spring.

Connected to the lower end of the tube there is a cutter head which has a number of cutters (minimum of two) preferably four which are radially located in the body which have cutting surfaces on their outer edges and which are spring biased to be normally within the periphery of the cutting head and at this position are spaced at the inner ends by the distance such as to enable them to cooperate with the tapered end of the shaft and to be moved outwardly against their spring bias when the shaft is moved axially relative to the four inner ends.

That is as the shaft is moved downwardly in the tube the tapered end enters the space bounded by the cutters and on further downward movement the blade cutters move outwardly beyond the periphery of the cutting head and, provided this is rotating whilst this is being done, the cutters can cut off the pipe internally in which the cutter head is located.

Located around the tube there is a pushing plate which is adapted to be moved along the tube and locking rings which may be threadably connected to a thread on the outside of the tube so that the location of the pushing plate along the length of the tube can be varied.

The operation of the plate device is that the required cutting head is located on the tube, by being screwed onto a thread thereon and the position of the cut is ascertained from the end of the pipe which is to be cut and the locking ring is located upon the tube at a position so that when the pushing plate associated with this contacts the outer surface of the pipe at the required distance there along.

A drill is then connected to the end of the shaft and on rotation of the drill the shaft and the tube rotates together, because of the shape of the shaft coacting with the apertures in the location members fixed to the tube when there is an inward pressure on the shaft this moves axially relative to the rotating tube the tapered end of the shaft enters the space between the cutters and causes the cutters to be moved outwardly and the the outward movement can continue with further downward pressure on the shaft until the pipe is cut. When the rotation of the drill ceases then the rotation of the tube and the cutting head also ceases and as the inward pressure by the drill is removed the shaft is moved back by its spring, the tapered end moves from the position between the cutters, and the cutters retract via the cutter springs and are retained within the cutter body.

It will be seen that the pipe cutter of the invention enables a quick and efficient means of cutting pipes from the interior thereof so that there is no part of the cutting mechanism, except ultimately the tips of the cutters which extend beyond the pipe to be cut and as such there is no likelihood of damage. There are occasions when a pipe needs to be cut when it is either closely adjacent a surface through which it passes or even below the surface at which it is located and it has been conventionally effectively impossible to do this or, at to do it neatly and without likely damage to the surface or surround. If it is required to cut off a pipe below a surface this can readily be achieved in a neat and workman like manner without requiring reparation work.

### ANNEXURE

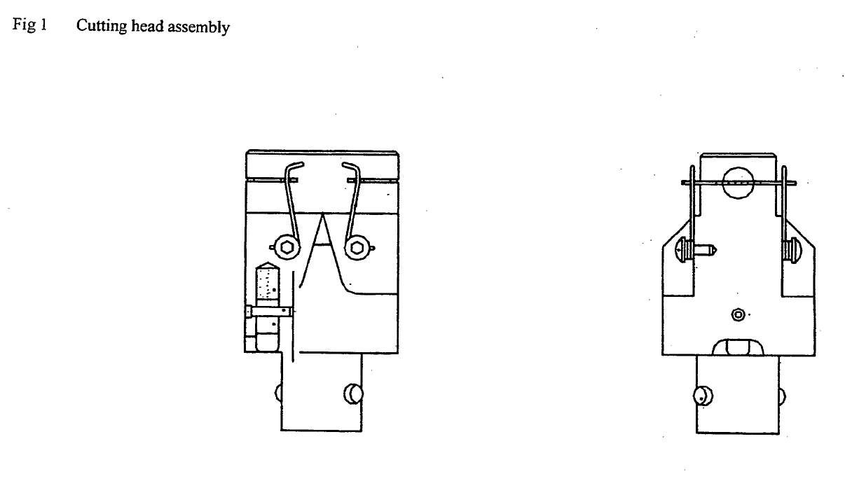

FIG. 1 Cutting bead assembly
1 Cutting blades
2 Retaining springs
3 Spring retaining screws
4 Release pin spring
5 Release spring stop
6 Release pin
7 Locating pin
8 Cutting head

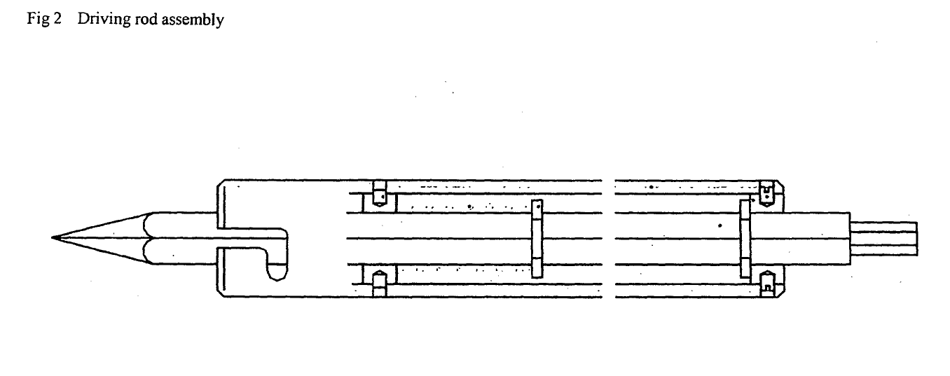

FIG. 2 Driving rod assembly
1 Retaining grub screw
2 Return spring
3 Spring stop
4 Tool shaft
5 Drive shaft
6 Retaining collar
7 End locator locker locking pin

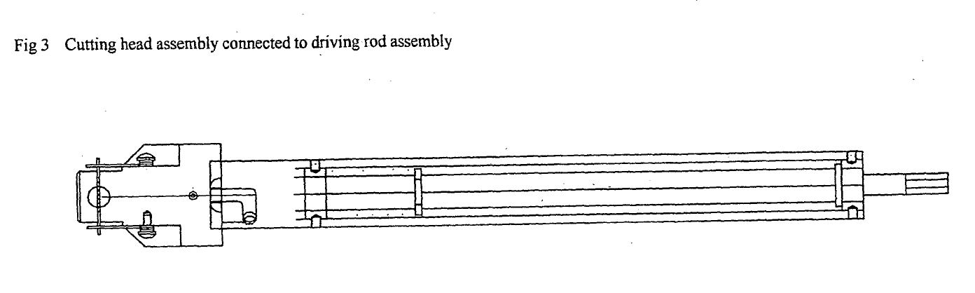

FIG. 3 Cutting bead assembly connected to driving rod assembly

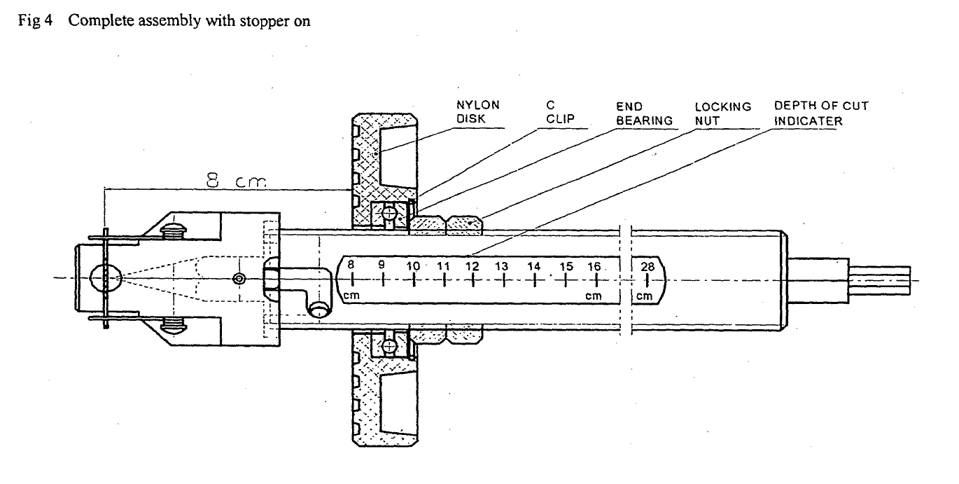

FIG. 4 Complete assembly with stopper on Description as per diagram

1. A device to cut a pipe from its interior surface in an outward direction, said device including:
a hollow tubular body adapted at one end for releasable attachment to a cutting head;
cutting means connected to said cutting head, said cutting means capable of being biased against said interior surface for cutting thereof; and
a driving member within, and operably connected to, said tubular body enabling rotation of said body, said driving member further being biased to move in a longitudinal direction when pressure is applied to one end of said driving member sufficient to engage and subsequently maintain said cutting means against said interior surface until said pipe is cut through.

2. A device as defined in claim 1 wherein, said cutting means comprises a multiple of cutters, arranged circumferentially within said cutting head.

3. A device as defined in claim 2 wherein, said driving member is adapted to enter centrally between said multiple of cutters when said pressure is applied to bias said multiple cutters against said interior surface.

4. A device as defined in claim 3 wherein there are two of said cutters.

5. A device as defined in claim 3 wherein there are four of said cutters.

6. A device as defined in claim 2 wherein, each of said multiple cutters is a rotatable wheel with a cutting edge on the periphery of said wheel.

7. A device as defined in claim 1 wherein, said tubular body has a threaded exterior surface to accommodate a complementary internally threaded plate which can be rotated on said tubular body to bear upon an exposed end of said pipe to provide a depth guide for said cutting means to cut said pipe at a required location.

8. A device as defined in claim 7 wherein, said plate is held in a required position on said threaded surface by one or more locking rings.

9. A method to cut a pipe from its interior surface in an outward direction, said method including:
providing a device as defined in claim 1 with a said cutting head selected appropriate for the internal diameter of said pipe to be cut;
placing said device into the interior of said pipe at a required depth for said cut; and
applying said pressure to engage said cutting means against said interior surface while applying rotational motion to said driving member until said pipe is cut through.

10. A method as defined in claim 9 wherein, said rotational motion is supplied by a powered drill operably connected to said driving member.
